(19) United States
(12) Patent Application Publication
(10) Pub. No.: US 2026/0040001 A1
(43) Pub. Date: Feb. 5, 2026

(54) Audio Enhancement Processing for Ambient Sound

(71) Applicant: Sonitum Inc., Malibu, CA (US)

(72) Inventors: Lawrence Guterman, Studio City, CA (US); Anuj Gujar, Woodland Hiills, CA (US); Jody Winzelberg, San Mateo, CA (US)

(73) Assignee: Sonitum Inc., Malibu, CA (US)

(21) Appl. No.: 18/789,415

(22) Filed: Jul. 30, 2024

(51) Int. Cl. H04R 3/00; H04R 5/02; H04R 5/027; H04R 5/04

(52) U.S. Cl. CPC H04R 3/005; H04R 5/02; H04R 5/027; H04R 5/04; H04R 2201/401; H04R 2203/12; H04R 2205/024

(57) ABSTRACT

System and techniques for audio enhancement processing for both electronically delivered audio signals and ambient sound. Ambient sound processing includes audio enhancement processing of signals captured by ambient microphones communicatively coupled to an audio enhancement processing apparatus as well as media provided by a storage device. Audio enhancement processing is provided for a user utilizing an electronic device that is directly or indirectly communicatively coupled to accessory microphones.

### FIELD OF TECHNOLOGY

This patent application relates generally to hearing assists, and more specifically to hearing assist systems and techniques that improve the intelligibility or appreciation of audio signals by a person with hearing impairment in an environment with ambient sound.

### BACKGROUND

Typically, audio playback devices such as car or home audio systems or computing devices (including smartphones, tablets, or laptop computers) provide limited audio adjustment capabilities. Such devices may incorporate audio output connection capabilities enabling audio playback via loudspeakers or headphones, as well as hardware-based or software-based audio enhancement or personalization processing functionality such as spectral correctors (a.k.a. “equalizers”).

While the aforementioned techniques may provide for limited capabilities, manually controlling the audio enhancement or personalization process may be inconvenient for a user as a control panel or user interface may not be suitable or effective to enable the user to attain a desired or optimal listening enhancement. This issue is particularly pronounced for users who aim for this enhancement to mitigate/or compensate for their personal hearing loss. Furthermore, as the audio enhancement is applied to audio material (which may include, for instance, music, movie or communication audio) delivered electronically from the device, the audio enhancement does not affect or enhance ambient sounds (sounds emanating from other sound sources that may be active and audible in the user's environment).

Though hearing aids may include microphones, existing hearing aids typically suffer from limitations in audio processing capability and affordances, which prevent a consumer from optimizing the enhancement provided by hearing aids to their personal need or preference in all daily encountered listening conditions. Furthermore, the microphones on hearing aids are positionally fixed. Accordingly, the microphone is generally disposed at a distance from an audio source as they are located on the hearing aids. Such a distance decreases the ability to provide the desired hearing experience due to background noise that the microphone will also sense.

### SUMMARY

Described herein are systems and techniques for audio enhancement processing for ambient sound.

Clause 1. A system comprising: a plurality of microphones; an audio output device; and an audio subsystem, configured to: receive microphone data from each of the plurality of microphones; determine one or more sound sources from the microphone data, wherein the determining the one or more sound sources comprises: determining locations for each of the one or more sound sources relative to an electronic device associated with the audio subsystem; and determining associated sounds from the microphone data for each of the one or more sound sources; tune at least one of the associated sounds; and output the tuned sounds to the audio output device.

Clause 2. The system of claim 1, further comprising: the electronic device, wherein the plurality of microphones and the audio subsystem are disposed within the electronic device.

Clause 3. The system of claim 2, wherein a first microphone is disposed on a front of the electronic device and a second microphone is disposed on a back of the electronic device.

Clause 4. The system of claim 2, wherein the audio output device comprises a loudspeaker disposed within the electronic device.

Clause 5. The system of claim 2, wherein the audio output device comprises a speaker communicatively coupled to the electronic device.

Clause 6. The system of claim 5, wherein the outputting the tuned sounds comprises communicating audio data to the speaker for output by the speaker.

Clause 7. The system of claim 1, wherein the audio subsystem is further configured to: determine a first identified sound of the associated sounds; determine that the first identified sound is desired; and select a tuning profile for the first identified sound.

Clause 8. The system of claim 7, wherein the tuning is performed with the tuning profile.

Clause 9. The system of claim 7, further comprising: a memory, wherein the tuning profile is stored and received from the memory.

Clause 10. The system of claim 7, wherein the audio subsystem is further configured to: determine a second identified sound of the associated sounds; and determine that the second identified sound is undesired, wherein the tuning comprises deemphasizing the second identified sound.

Clause 11. A method comprising: receive microphone data from each of a plurality of microphones; determine one or more sound sources from the microphone data, wherein the determining the one or more sound sources comprises: determining locations for each of the one or more sound sources relative to an electronic device; and determining associated sounds from the microphone data for each of the one or more sound sources; tune at least one of the associated sounds; and output the tuned sounds to an audio output device.

Clause 12. The method of claim 11, wherein the plurality of microphones are disposed within the electronic device.

Clause 13. The method of claim 12, wherein a first microphone is disposed on a front of the electronic device and a second microphone is disposed on a back of the electronic device.

Clause 14. The method of claim 12, wherein the audio output device comprises a loudspeaker disposed within the electronic device.

Clause 15. The method of claim 12, wherein the audio output device comprises a speaker communicatively coupled to the electronic device.

Clause 16. The method of claim 15, wherein the outputting the tuned sounds comprises communicating audio data to the speaker for output by the speaker.

Clause 17. The method of claim 11, further comprising: determine a first identified sound of the associated sounds; determine that the first identified sound is desired; and select a tuning profile for the first identified sound.

Clause 18. The method of claim 17, wherein the tuning is performed with the tuning profile.

Clause 19. The method of claim 17, wherein the tuning profile is stored and received from a memory.

Clause 20. The method of claim 17, further comprising: determine a second identified sound of the associated sounds; and determine that the second identified sound is undesired, wherein the tuning comprises deemphasizing the second identified sound.

These and other embodiments are described further below with reference to the figures.

### BRIEF DESCRIPTION OF THE DRAWINGS

The included drawings are for illustrative purposes and serve only to provide examples of possible structures and operations for the disclosed inventive systems, apparatus, methods, and computer program products for audio enhancement processing for ambient sound. These drawings in no way limit any changes in form and detail that may be made by one skilled in the art without departing from the spirit and scope of the disclosed implementations.

FIGS. 1-4 are representations of systems for audio enhancement processing for ambient sound, in accordance with certain embodiments.

FIG. 5 is a block diagram illustrating components of an audio personalization processing module, in accordance with certain embodiments.

FIG. 6 is a representation of an electronic device, in accordance with certain embodiments.

FIG. 7 is a representation of a user interface, in accordance with certain embodiments.

FIG. 8 is a flowchart illustrating a technique for spatial audio tuning, in accordance with certain embodiments.

FIG. 9 illustrates a block diagram of an example computing system, in accordance with some embodiments.

### DETAILED DESCRIPTION

### Introduction

In the following description, numerous specific details are outlined to provide a thorough understanding of the presented concepts. The presented concepts may be practiced without some or all of these specific details. In other instances, well-known process operations have not been described in detail to not unnecessarily obscure the described concepts. While some concepts will be described in conjunction with the specific embodiments, it will be understood that these embodiments are not intended to be limiting.

It is appreciated that, for the purposes of this disclosure, when an element includes a plurality of similar elements distinguished by a letter or follow-on numeral following the ordinal indicator (e.g., “236A” and “236B” or “236-1” and “236-2”) and reference is made to only the ordinal indicator itself (e.g., “236”), such a reference is applicable to all the similar elements. Certain figures may each include elements that include the same two ending digits for ordinal indicators (e.g., X04 and Y04).

In such situations, the same two ending digits may indicate elements that are the same or similar between the figures. It is appreciated that, in such situations, disclosure provided for the element in one figure may apply to the element in another figure.

The term “source signal” may represent a talker's voice, or, generally, any other kind of transmitted or recorded audio signal (for instance, a music or movie soundtrack component or “stem”), such as may be originated by one or more musical instruments, human character voices, sound effects, or any sound producing apparatus.

The term “profile” refers to a set of audio enhancement (or personalization) processing parameters.

Reference is made in the following description to the “audio signal chain.” In order for people with hearing loss to be able to understand a source signal via electronic communication or transmission (including telephone calls and video conference calls such as Zoom or Teams for example), it is desirable to provide a product and/or service which generates an audio profile of the entire hardware and software signal chain from the source end to the listener end, and also accounts for the listener's hearing acuity or impairment.

Such an audio profile may include, but may not be limited to: (1) information about the frequency response characteristics of the microphone associated with an electronic device (e.g., cell phone, PSTN handset, headset microphone, and/or other such devices), the peculiarities and specifications of the audio processing effects associated with the network codecs, the response characteristics of the loudspeaker or loudspeakers associated with the electronic device (e.g., cellular phone, PSTN handset, headset loudspeakers, computer loudspeakers, and/or other such devices), as well as (2) the specific hearing profile of the listener (audiogram-based prescription and associated response curve, noise reduction preferences, compression and wide dynamic range compression preferences, to name a short but not exhaustive list of elements associated with the “hearing profile” of the listener). This is because people with hearing loss may suffer from different levels of degraded hearing at different frequencies and/or may suffer from greater sensitivity to louder sounds (hyperacusis) at different frequencies.

Such a profile may allow for a user of an audio profile to utilize any electronic device that has audio outputs for hearing assists and, thus, allows for the user an enhanced hearing experience regardless of whether traditional hearing aids are used. The profile allows for hearing enhancement to be provided by such electronic devices while taking into account the various characteristics of the audio output component of the electronic device.

An audio signal that is personalized to compensate not only for the devices being used to hear the signal, but also the specific and characteristic acoustic capability of the listener's ears (outer, middle and inner, including the cochlear response, where deficits account for the most common type of age-related hearing loss, sensorineural loss), enhances the hard-of-hearing listener's ability to understand speech when using such devices. The creation of a hearing profile for a listener based on the aforementioned elements enhances the ability of the listener to understand speech (note: “speech discrimination” is synonymous with “understanding of speech” and is the term customarily used in the audiology field) or to experience the psychoacoustic effect of music with greater fidelity to the original quality of the live audio or live streamed audio.

Descriptions of solutions for personalized hearing enhancement include the systems and techniques described in U.S. Pat. No. 9,933,990, entitled Topological Mapping of Control Parameters, U.S. Pat. No. 10,506,067, entitled Dynamic Personalization of a Communication Session in Heterogeneous Environments, U.S. Pat. No. 10,652,674, entitled Hearing Enhancement and Augmentation via a Mobile Computer Device, and U.S. patent application Ser. No. 18/660,764, entitled Audio Perception Tuning Flow, and U.S. patent application Ser. No. 18/753,796, entitled Source-Dependent Audio Enhancement Processing, all of which are incorporated herein by reference in their entirety for all purposes.

### Audio Enhancement Processing for Ambient Sound Overview

Described herein are systems and techniques providing audio enhancement processing for both electronically delivered audio signals and ambient sound. Ambient sound processing may be provided by application of the audio enhancement processing to signals captured by ambient microphones communicatively coupled to an audio enhancement processing apparatus, as described herein.

In various embodiments, audio enhancement processing as described herein may be provided for a user that wears earphones that are directly or indirectly communicatively coupled (e.g., where electronic signals may be communicated) to accessory microphones. Various embodiments of such a configuration may include, for example, microphones that are built into an electronic device (e.g., smartphone, desktop computer, laptop computer, wearable electronic device, and/or other such electronic devices) having a wired or wireless connection to the audio out (e.g., earphones) and/or microphones communicatively coupled to an electronic device via a wired or wireless connection. Additionally or alternatively, audio enhancement processing may also be conducted through processing circuitry embedded within a head-worn or user-worn device. The devices may include both microphones and loudspeakers. Various examples of such devices may include obstructing earphones or earbuds which significantly impede the natural propagation of ambient sound to a user's eardrum as well as non-obstructing or partially-obstructing devices, such as augmented reality headsets or bone conduction headsets.

The audio processing system and techniques described herein may provide a user with hearing enhancement beyond ambient sound audibility enhancement. Such benefits may include spatial selectivity (e.g., employing a microphone array for beamforming and/or via machine learning), environment noise reduction (e.g., through exploitation of inter-microphone signal coherence and/or via machine learning), environment noise “drowning” (e.g., by making softer signal components audible above ambient noise), and/or for speech intelligibility improvement.

In certain embodiments, the systems and techniques described herein may allow for strategic placement of microphones. For example, the microphones described herein may be free-standing or coupled to a variety of different electronic devices, such as a smartphone. The microphone and/or electronic device may, thus, be strategically placed based on the sound source that the user wishes to hear. Thus, the microphone and/or electronic device may, for example, be placed on a table in a noisy environment proximate to a speaker that the user wishes to hear. The microphone may then provide audio data for tuning and/or output through an output device, such as a headphone or earbud, for output to the user.

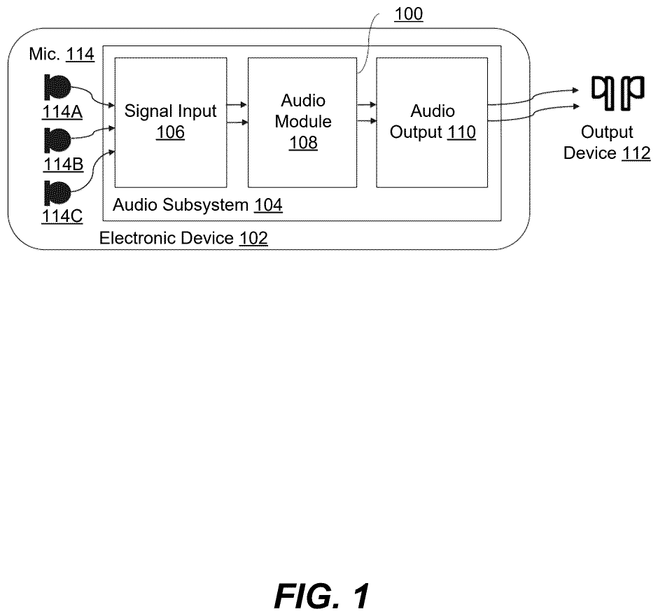

FIGS. 1-4 are representations of systems for audio enhancement processing for ambient sound, in accordance with certain embodiments. FIGS. 1-4 may illustrate configurations of systems that provide for audio enhancement processing for ambient sound.

FIG. 1 illustrates system 100 that includes electronic device 102. Electronic device 102 may be any electronic device such as a laptop, desktop, smartphone, tablet, wearable device, and/or any other device described herein.

Electronic device 102 may be electrically coupled to output device 112, which may include any type of or any number of devices that output audio data to a user, such as earbuds, headphones, loudspeakers, bone conduction devices, and/or other such devices. Audio data processed by electronic device 102 (e.g., by audio subsystem 104) may be communicated (e.g., via any wired and/or wireless electrical or data connection) to output device 112 for output to the user. Output device 112 may be an output device that allows for the distance between electronic device 102 and output device 112 to vary (e.g., their wired and/or wireless electronic or data connection may allow for the distance between electronic device 102 and output device 112 to vary). In certain embodiments, output device 112 may be an earbud, earphone, headphone, and/or other wearable device.

Electronic device 102 may include one or a plurality of microphones 114. The embodiment of FIG. 1 illustrates electronic device 102 with three microphones, microphones 114A, 114B, and 114C, but other embodiments may include any number of microphones. In various embodiments, microphones 114 may each be positioned in a different position of electronic device 102 (e.g., within a different position on the body of electronic device 102). Thus, for example, each of microphones 114A, 114B, and 114C may be positioned in the front, back, top, bottom, or sides of electronic device 102.

Microphones 114 may be configured to detect audio of the environment proximate to electronic device 102 (e.g., of the environment around electronic device 102) and provide microphone data pertaining to the detected audio. Microphones 114 may be wired and/or wirelessly electrically coupled to audio subsystem 104 to, for example, provide such microphone data to audio subsystem 104.

Audio subsystem 104 may be an audio processing module implemented by the components of electronic device 102. Thus, the components of audio subsystem 104 (e.g., signal input 106, audio module 108, audio output 110, and/or other such components explicitly stated or implied) may be implemented by one or more memory, processors, and other components of electronic device 102.

Audio subsystem 104 may include signal input 106, audio module 108, and audio output 110. Signal input 106 may be configured to receive microphone data from the various microphones 114. Signal input 106 may receive microphone data from one or a plurality of microphones 114 that may be an audio stream of sounds of the environment around electronic device 102. Signal input 106 may be configured to perform signal input functions such as analog-to-digital signal conversion, microphone selection (e.g., determining which of the plurality of microphones 114 to receive data from), microphone signal front end processing (e. g. echo cancellation and/or adjustments for input gain and/or scaler adjustments, e.g., with audio module 108, such as a filter bank of the audio module as described herein), and/or other operations associated with operation of microphones 114 and/or receipt of microphone data from microphones 114.

Audio module 108 may be configured to create and/or tune audio data that may be provided to output device 112 for output to a listener (e.g., the user). Tuning of audio data may include, for example, tuning of the ambient sounds determined by microphones 114 and/or audio data of media that the user is listening to, such as audio of conversations and/or media (e.g., music, podcast, movie, television, and/or other such media). In various embodiments, such tuning by audio module 108 may be via a digital signal processor (DSP) filter bank or other appropriate component and may include, for example, multi-band audio signal compression changes, changes in equalization, changes in compression threshold, and/or changes in wide dynamic range compression including, for example, changes in the time domain parameters such as attack and release times of a digital signal processor (DSP) filter bank. Such operations may be performed in real time or semi-real time (e.g., in a manner that allows for tuning of audio output to a listener while the listener may be engaged in conversation).

Audio module 108 may, in certain embodiments, allow for adjustment of the parameters of tuning that is applied. Such adjustments may be manually performed by the user or automatically conducted (e.g., via stored algorithms or logic associated with audio module 108). Thus, the amplification and character (frequency and dynamic range) of voices or of nearby sounds (e.g., specific sounds or background noise in general) may be adjusted to different levels, allowing for such voices and/or sounds to be processed by audio module 108 in a different manner than other sounds that are proximate the user. Such processing may allow such sounds to, for example, be output in a manner that allows such sounds to more prominently be heard by the user including, for example, a user with hearing loss who may benefit from such processing.

Adjustment of parameters may be via, for example, a GUI on electronic device 102. In certain embodiments, a user may listen to live sounds and/or recorded sounds (whether recorded by the user or provided by another source, such as an audio tuning service) and adjust the parameters of a tuning profile via, for example, a GUI. Such a tuning profile may, when the user is satisfied, be saved to electronic device 102 (e.g., a memory of electronic device 102) and/or to the cloud.

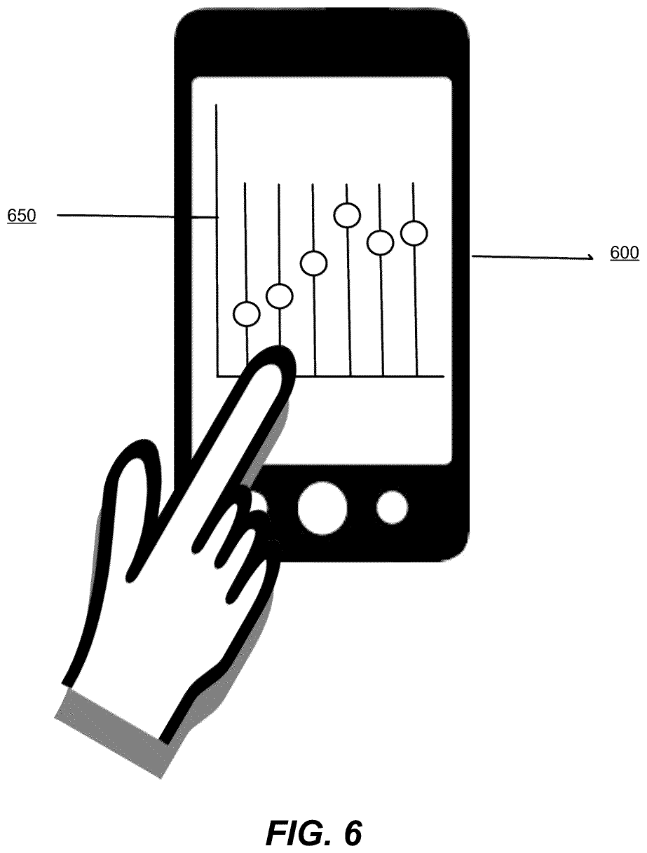

FIG. 6 is a representation of an electronic device, in accordance with certain embodiments. FIG. 6 depicts electronic device 600 that includes tuning controller 650, which may be presented as a GUI. Electronic device 500 may include a user interface that allows the user to send commands to audio module 108 and/or tuning controller 650 for adjustment of parameters of the tuning profile. In certain embodiments, tuning controller 650 allows the user to provide inputs that cause audio module 108 to perform tuning operations on recorded or live sounds that the user is listening to and/or to any other media in real time or semi-real time (e.g., in a manner that allows for the user to provide adjustments while listening). As the user adjusts parameters in tuning controller 650, tuning controller 650 provides data (e.g., controller messages) to audio module 108. Such controller messages may be configured to change DSP parameters in audio module 108. In various embodiments, such tuning by audio module 108 may be via a digital signal processor (DSP) filter bank or other appropriate technique.

For example, the user may wish to alter the frequency response of the audio output by adjusting the parameters in the equalizer contained in audio module 108. Alternatively, the user may wish to alter the compression thresholds as a function of frequency, or the attack and release times, as described herein. The user may also wish to adjust the parameters associated with “Frequency Transposition” or “Frequency Compression”, two DSP algorithms. The algorithms described herein are examples and are not an exhaustive list. Audio module 108 may be equipped with any number of signal processing algorithms, not limited to those described herein.

In another embodiment, an artificial intelligence (AI) system may be trained on the preferences of the user and configured to perform automatic adjustment of the parameters. Additionally or alternatively, the AI system may determine the sound and/or speech preferences of the user and automatically generate a tuning profile for media and/or speaker that the listener interacts with or listens to. Such a tuning profile may then be applied or may be provided to the user for further tuning or may be used by audio module 108 for tuning of audio data.

The AI system may be configured to separate out background chatter (e.g., steady state noise as well as transient noise such as, for example, clashing voices in a restaurant) from the sounds and/or speech that the user is listening to. The AI system may then accordingly suppress the unwanted background chatter.

Such a technique may be utilized to the benefit of not only users who suffer from audiogram-presentable clinical hearing loss, but users with hidden hearing loss. Individuals with hidden hearing loss represent a large percentage of the population. Hidden hearing loss users may suffer from subpar hearing due to a condition which affects the biological components that control speech-to-noise ratio in the synapse between the cochlear hair cells and the auditory nerves in the brain. Such hidden hearing loss may manifest in, for example, situations where a user with supposedly normal hearing that visits a restaurant may not hear voices well.

Audio data tuned by audio module 108 may be communicated to audio output 110. Audio output 110 may be configured to, for example, provide digital-to-analog conversion and amplification to audio data tuned by audio module 108. Audio output 110 may then provide such converted and tuned audio data to output device 112 may any wired and/or wireless communication technique.

In various embodiments, system 100 and the plurality of microphones 114 allows for amplification of specific sounds of interest to the user. Such sounds may include, for example, sounds emanating from specific media, the user's voice, speech of others, ambient sounds, and/or other such sounds of interest.

In certain situations, amplifying a user's own voice is important when wearing hearing instruments because the occlusion of sound by an obstructing earphone may result in an unnatural perception of self-voice. However, too much amplification may be disturbing to the user during conversation. Electronic device 102 may be configured to allow a user to adjust the tuning of audio data by audio module 108 so that the user's own voice sounds natural to the user. In various embodiments, the user may adjust amplification, frequency specific adjustments, and/or dynamic range adjustments. In certain embodiments, such adjustments may be performed to allow the user to clearly hear his or her own voice without interfering with the main audio that the user is listening to, due to the configuration of the microphones.

Amplifying all sounds uniformly results in closer sounds being louder than sounds that are further away. In certain situations, a user may be more interested in hearing sounds that are further away. Electronic device 102 may be configured to allow a user to adjust the tuning of audio data by audio module 108 to adjust the character (e.g., frequency and dynamic range) of certain sounds, whether near or far, to divide the sound scene into acoustic zones (e.g., with different configurable personalization parameters).

In certain embodiments, the electronic device 102 may provide for environmental noise reduction (e.g., through inter-microphone signal coherence and/or machine learning), provide for environmental noise “drowning” (e.g., by making softer signal components audible above other noise), and/or provide for speech intelligibility improvement.

In various embodiments, positioning the plurality of microphones 114 at different portions of electronic device 102 allows for audio module 108 to determine the position of audio sources. Such determination may be via, for example, acoustic triangulation, parametric sound field modeling, or other spatial analysis techniques. For example, microphone data may be analyzed to identify direct and diffuse components using single or multi-channel filters, which may the allow for the estimation of sound parameters to identify direct or diffuse components of sound and their associated positions. Based on such techniques, audio module 108 may determine the location that a sound is emanating from relative to electronic device 102.

In certain embodiments, determination of the location of the audio source may be combined with stored audio profiles (e.g., stored within memory on electronic device 102 and/or on a network that electronic device 102 is communicatively coupled to). Thus, for example, such profiles may include the voice profile of the user that includes data directed to the characteristics of the user's voice. Audio module 108 may then match the sounds of a voice sensed by microphones 114 to the voice profile, to determine that the voice is the user's voice. Additionally or alternatively, a location of the voice relative to electronic device 102 may also be determined. If the voice is determined to be located close to electronic device 102 (e.g., within 10 feet), audio module 108 may determine that such a voice is more likely to be the user's voice, as a user is typically located close to their electronic device. Accordingly, the audio module 108 may determine that such a voice is the user's voice and apply the tuning profile associated with the user to the voice.

In an additional example, an audio source may be determined to be located proximate to the user. Such an audio source may match a voice profile of a contact of the user's and/or may be determined to be a human voice. Audio module 108 may then apply the appropriate tuning profile (e.g., the tuning profile associated with the contact and/or with a human voice) to the audio source if the user has a setting for enhancing voices that the user is in conversation with, enhancing specific contacts, and/or provides an indication to electronic device 102 to enhance certain voices proximate to the user.

As a further example, an audio source may be determined to be a sound of interest to the user (e.g., through preset settings or from indications provided by the user to electronic device 102). Audio module 108 may apply the appropriate tuning profile to enhance such a sound of interest.

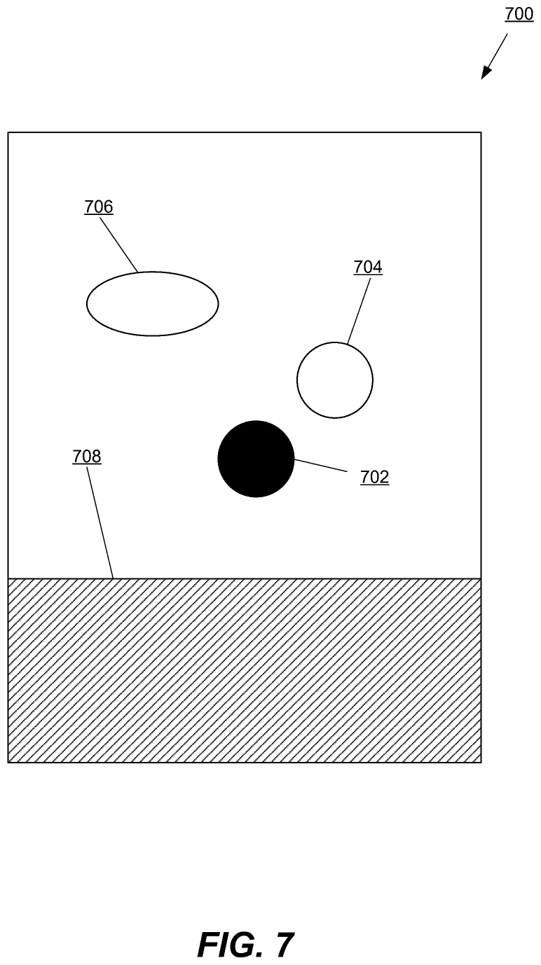

FIG. 7 is a representation of a user interface, in accordance with certain embodiments. FIG. 7 illustrates GUI 700, which may be a GUI provided on an electronic device. GUI 700 may illustrate the determined positions of sound sources from microphones 114. Thus, GUI 700 may illustrate the determined positions of user 702, determined human voice 704, audio source 706, and background sound 708. The locations of user 702, determined human voice 704, audio source 706, and background sound 708 may be determined from data provided by microphones 114 by audio module 108 and displayed on GUI 700.

GUI 700 may be configured to allow a user to select one or more of user 702, determined human voice 704, audio source 706, and background sound 708, as well as other determined audio sources. Based on the selection, the user may cause audio module 108 to emphasis, deemphasis, and/or otherwise tune the audio output by audio module 108 to output device 112 for the audio source. Thus, upon selection of one or more of user 702, determined human voice 704, audio source 706, and background sound 708, as well as other determined audio sources, a further graphical indication may be provided on GUI 700 allowing for the user to adjust the tuning profile for the selected audio source (e.g., that of tuning controller 650 or a similar such GUI).

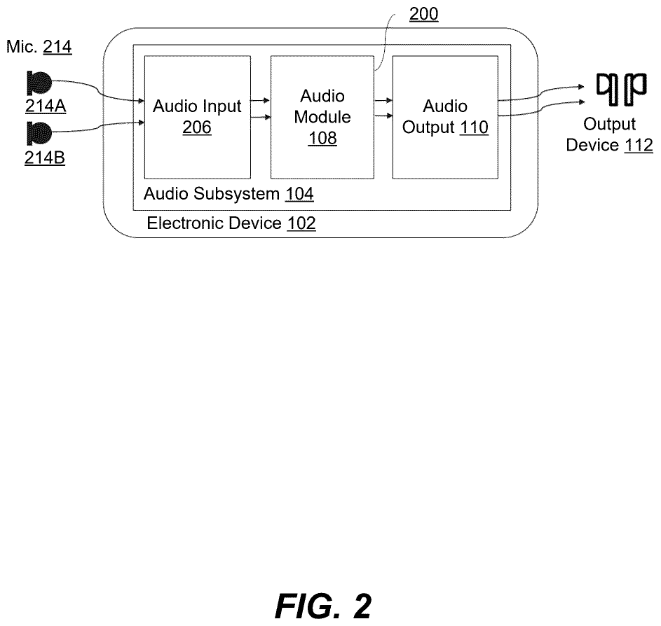

FIGS. 2-4 may be other embodiments of systems. In various embodiments, the systems of FIGS. 2-4 may be variations of system 100 of FIG. 1 and components of the systems of FIGS. 2-4 may be similar to that of FIG. 1. The systems of FIGS. 2-4 may also provide ambient sound enhancement according to the techniques described herein.

FIG. 2 illustrates system 200 where microphones 214 (e.g., microphones 214A and 214B) may be communicatively coupled to electronic device 102, but disposed in a manner where the physical distance between microphones 214 and electronic device 102 may vary. Thus, microphones 214 may be communicatively coupled to electronic device 102 via a wired or wireless connection.

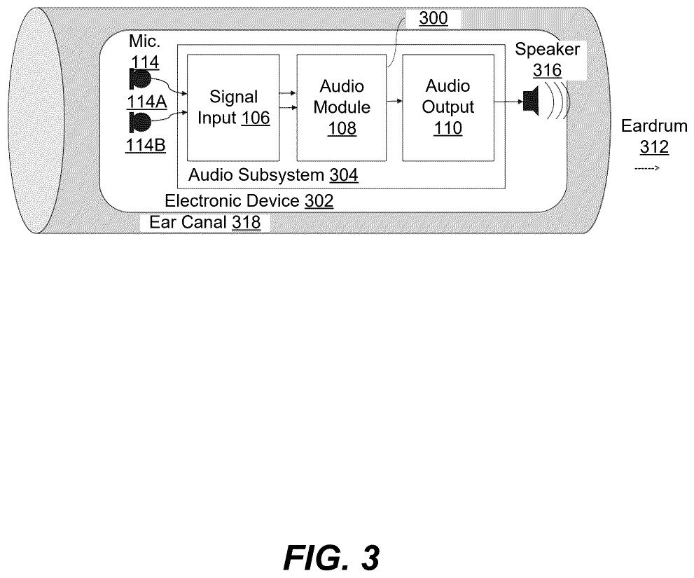

FIG. 3 illustrates system 300 where electronic device 302 where microphones 114 (e.g., microphones 114A and 114B) is disposed within electronic device 302. Electronic device 302 may further include speaker 316, which may be embedded within electronic device 302 (e.g., disposed within a body or casing of electronic device 302).

In certain embodiments, electronic device 302 may be, for example, an obstructing earbud configured to be disposed within ear canal 318 of a user and configured to output sound to eardrum 312 with speaker 316. In certain embodiments, disposing of electronic device 302 within ear canal 318 may impede the natural propagation of ambient sound to eardrum 312. In such a situation, audio module 108 may be configured to enhance ambient sound of the environment proximate the user to allow for the user to better hear ambient sound (e.g., enhance such sounds in a manner where the user may be able to hear as normal without an obstruction in ear canal 318.

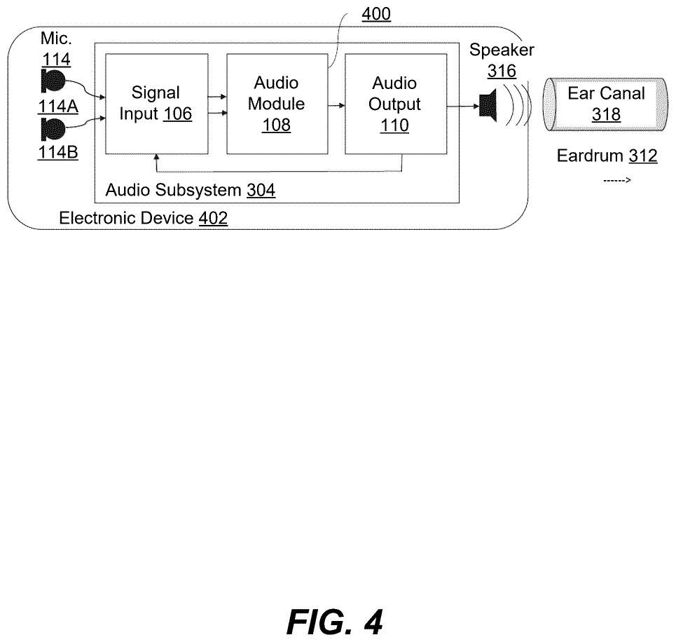

FIG. 4 illustrates system 400, including electronic device 402, that may include embedded microphones 114 and speaker 316. Electronic device 402 may, in certain embodiments, be an acoustically transparent device that is worn by the user in a manner where the user's ear canal 318 is unobstructed or partially obstructed. Thus, electronic device 402 may be an augmented reality headset, a bone conduction headset, a hearing aid, and/or another such device. In certain embodiments, audio output 110 may provide feedback to signal input 106 to, for example, allow signal input 106 to provide audio feedback cancellation.

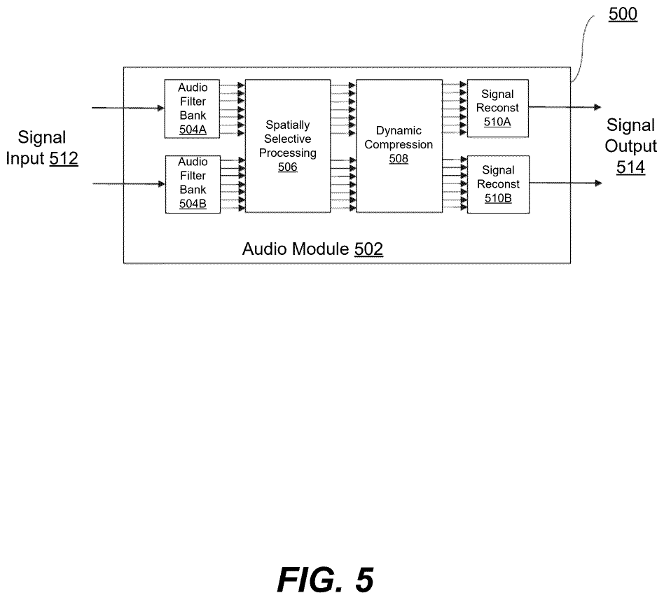

FIG. 5 is a block diagram illustrating components of an audio personalization processing module, in accordance with certain embodiments. FIG. 5 illustrates system 500 that allows for spatial selectivity (e.g., employing microphone array beamforming and/or machine learning to provide spatial selectivity).

System 500 includes audio module 502 that includes audio filter banks 504A and 504B, spatially selective processing 506, dynamic compression 508, and signal reconstruction modules 510A and 510B.

Signal input 512 from the microphones may be processed by audio module 502. The embodiment of system 500 may receive signal input 512 from a plurality of microphones, such as two microphones (one for each audio filter bank 510). Other embodiments may receive data from any number of microphones. Such embodiments may include a specific number of audio filter banks, each audio filter bank associated with a specific microphone. Additionally or alternatively, audio filter banks 504 may receive data from any number of microphones.

Data processed by audio filter banks 504 may be provided to spatially selective processing 506. Spatially selective processing 506 may determine audio sources and their location relative to the input device of audio module 502 (e.g., the microphones that are sensing the sound). Such determination may be via audio triangulation, parametric sound field modeling, or other such spatially selective processing. For example, microphone data may be analyzed to identify direct and diffuse components using single or multi-channel filters, which may the allow for the estimation of sound parameters to identify direct or diffuse components of sound and their associated positions. In certain embodiments, such processing may be via data within the frequency domain and/or in other such domains.

Due to spatial processing, certain audio sources may be selectively enhanced. That is, the sound from one audio source may be enhanced without also enhancing other sounds. Such enhancement may be according to the techniques herein and may be performed automatically or may be manually selected by the user (e.g., via GUI 700 of FIG. 7). Thus, spatially selective processing 506 may tune the sounds of specific audio sources, whether for enhancement or deemphasis.

Once data has been spatially processed, dynamic compression may be performed on the data by dynamic compression 508. In certain embodiments, such processing may be via data within the frequency domain and/or in other such domains. The processed signal may be then reconstructed with signal reconstruction modules 510, such as signal reconstruction modules 510A and 510B.

The reconstructed signal may then be output via signal output 514, which may be any output described herein. Signal output 514 may be data configured to cause an audio output, such as a earbud or headphone, to provide audio to a user.

Accordingly, the configuration of system 500 may provide a user the ability to emphasis certain sounds or sound sources in the audio provided by signal output 514. The user may, thus, be able to have an enhanced listening experience or be able to hear certain sound sources or certain sound aspects (e.g., dialogue in a movie) in a manner that is superior to even normal human hearing.

### Spatial Audio Tuning Technique

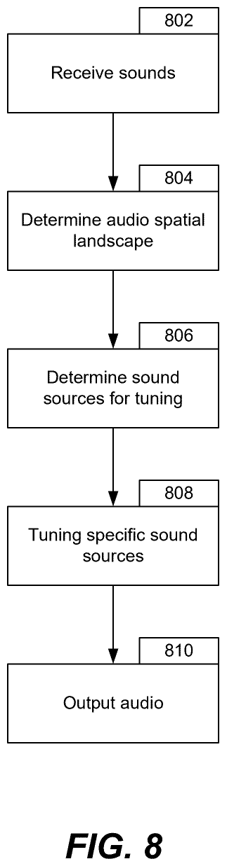

FIG. 8 is a flowchart illustrating a technique for spatial audio tuning, in accordance with certain embodiments. In 802, sounds proximate an electronic device may received by, for example, one or more microphones that are communicatively coupled to the electronic device. Such microphones may be embedded within the electronic device and/or may be wired or wirelessly coupled to the electronic device.

An electronic device with a plurality of associated microphones may allow for determination of an audio spatial landscape. That is, the plurality of microphones may be disposed at different locations and such an arrangement may allow for the determination, in 804, of the location of a sound source relative to the electronic device. The location of one or more sound sources located proximate to the electronic device (e.g., voices, media sounds, background noise, and/or other such sounds) may be determined according to the techniques described herein, such as via audio triangulation techniques.

In 806, one of more such sound sources may be tuned. The sound sources may be automatically or manually selected for tuning, according to the techniques described herein. Thus, for example, certain types of sounds (e.g., the voices of people that are speaking that are determined to be proximate to the user) may be automatically tuned and/or enhanced, via various tuning profiles, based on preset algorithms. Additionally or alternatively, a user may provide an indication (e.g., via a GUI) that certain sounds should be tuned.

Based on such selections, the specific sound sources may be tuned in 808. Such tuning may be according to various audio tuning profiles or tuned in real time, according to the techniques described in herein. Thus, tuning profiles may be created or stored for various media, voices, background noise, and/or other such noise. Such tuning profiles may enhance, deemphasis, or otherwise tune the sound in another manner, according to the needs and/or preferences of the user. Based on the type of sound source, the tuning profile may be applied to the sound source.

In 810, the tuned audio may be output and tuned sound may be provided to the user. Such output may be via one or more loudspeakers, earbuds, earphones, bone conduction, and/or other such techniques.

### Computing System Example

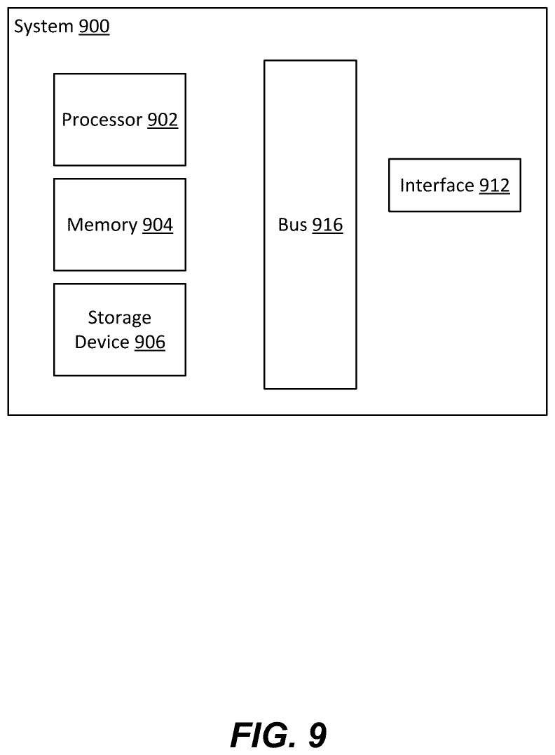

FIG. 9 illustrates a block diagram of an example computing system, in accordance with some embodiments. According to various embodiments, a system 900 suitable for implementing embodiments described herein includes a processor 902, a memory module 904, a storage device 906, an interface 912, and a bus 916 (e.g., a PCI bus or other interconnection fabric.) System 900 may operate as variety of devices such as a server system such as an application server and a database server, a user device such as a laptop, desktop, smartphone, tablet, wearable device, set top box, etc., or any other device or service described herein.

Although a particular configuration is described, a variety of alternative configurations are possible. The processor 902 may perform operations such as those described herein. Instructions for performing such operations may be embodied in the memory 904, on one or more non-transitory computer readable media, or on some other storage device. Various specially configured devices can also be used in place of or in addition to the processor 902. The interface 912 may be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

Any of the disclosed embodiments may be embodied in various types of hardware, software, firmware, computer readable media, and combinations thereof. For example, some techniques disclosed herein may be implemented, at least in part, by non-transitory computer-readable media that include program instructions, state information, etc., for configuring a computing system to perform various services and operations described herein. Examples of program instructions include both machine code, such as produced by a compiler, and higher-level code that may be executed via an interpreter. Instructions may be embodied in any suitable language such as, for example, Java, Python, C++, C, HTML, any other markup language, JavaScript, ActiveX, VBScript, or Perl. Examples of non-transitory computer-readable media include, but are not limited to: magnetic media such as hard disks and magnetic tape; optical media such as flash memory, compact disk (CD) or digital versatile disk (DVD); magneto-optical media; and other hardware devices such as read-only memory (“ROM”) devices and random-access memory (“RAM”) devices. A non-transitory computer-readable medium may be any combination of such storage devices.

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

While various embodiments have been described herein, it should be understood that they have been presented by way of example only, and not limitation. For example, some techniques and mechanisms are described herein in the context of fulfillment. However, the disclosed techniques apply to a wide variety of circumstances. Particular embodiments may be implemented without some or all of the specific details described herein. In other instances, well known process operations have not been described in detail in order not to unnecessarily obscure the techniques disclosed herein. Accordingly, the breadth and scope of the present application should not be limited by any of the embodiments described herein, but should be defined only in accordance with the claims and their equivalents.

### CONCLUSION

Although the foregoing concepts have been described in some detail for purposes of clarity of understanding, it will be apparent that certain changes and modifications may be practiced within the scope of the appended claims. It should be noted that there are many alternative ways of implementing processes, systems, and apparatuses. Accordingly, the present embodiments are to be considered illustrative and not restrictive.

1. A system comprising:
a plurality of microphones;
an audio output device; and
an audio subsystem, configured to:
receive microphone data from each of the plurality of microphones;
determine one or more sound sources from the microphone data, wherein the determining the one or more sound sources comprises:
determining locations for each of the one or more sound sources relative to an electronic device associated with the audio subsystem; and
determining associated sounds from the microphone data for each of the one or more sound sources;
tune at least one of the associated sounds; and
output the tuned sounds to the audio output device.

2. The system of claim 1, further comprising:
the electronic device, wherein the plurality of microphones and the audio subsystem are disposed within the electronic device.

3. The system of claim 2, wherein a first microphone is disposed on a front of the electronic device and a second microphone is disposed on a back of the electronic device.

4. The system of claim 2, wherein the audio output device comprises a loudspeaker disposed within the electronic device.

5. The system of claim 2, wherein the audio output device comprises a speaker communicatively coupled to the electronic device.

6. The system of claim 5, wherein the outputting the tuned sounds comprises communicating audio data to the speaker for output by the speaker.

7. The system of claim 1, wherein the audio subsystem is further configured to:
determine a first identified sound of the associated sounds;
determine that the first identified sound is desired; and
select a tuning profile for the first identified sound.

8. The system of claim 7, wherein the tuning is performed with the tuning profile.

9. The system of claim 7, further comprising:
a memory, wherein the tuning profile is stored and received from the memory.

10. The system of claim 7, wherein the audio subsystem is further configured to:
determine a second identified sound of the associated sounds; and
determine that the second identified sound is undesired, wherein the tuning comprises deemphasizing the second identified sound.

11. A method comprising:
receive microphone data from each of a plurality of microphones;
determine one or more sound sources from the microphone data, wherein the determining the one or more sound sources comprises:
determining locations for each of the one or more sound sources relative to an electronic device; and
determining associated sounds from the microphone data for each of the one or more sound sources;
tune at least one of the associated sounds; and
output the tuned sounds to an audio output device.

12. The method of claim 11, wherein the plurality of microphones are disposed within the electronic device.

13. The method of claim 12, wherein a first microphone is disposed on a front of the electronic device and a second microphone is disposed on a back of the electronic device.

14. The method of claim 12, wherein the audio output device comprises a loudspeaker disposed within the electronic device.

15. The method of claim 12, wherein the audio output device comprises a speaker communicatively coupled to the electronic device.

16. The method of claim 15, wherein the outputting the tuned sounds comprises communicating audio data to the speaker for output by the speaker.

17. The method of claim 11, further comprising:
determine a first identified sound of the associated sounds;
determine that the first identified sound is desired; and
select a tuning profile for the first identified sound.

18. The method of claim 17, wherein the tuning is performed with the tuning profile.

19. The method of claim 17, wherein the tuning profile is stored and received from a memory.

20. The method of claim 17, further comprising:
determine a second identified sound of the associated sounds; and
determine that the second identified sound is undesired, wherein the tuning comprises deemphasizing the second identified sound.
